(19) United States
(12) Patent Application Publication
(10) Pub. No.: US 2014/0067453 A1
(43) Pub. Date: Mar. 6, 2014

(54) SHARED ASSET MANAGEMENT

(71) Applicants: ANNA FILOMENA BUFI, ROMA (IT); CLAUDIO DE INGENIIS, ROMA (IT); FRANCESCA GUCCIONE, ROMA (IT); UGO MADAMA, ROMA (IT); SANDRO PICCININI, ROMA (IT); STEFANO PROIETTI, ROMA (IT); MILKO VACCARO, ROMA (IT)

(72) Inventors: ANNA FILOMENA BUFI, ROMA (IT); CLAUDIO DE INGENIIS, ROMA (IT); FRANCESCA GUCCIONE, ROMA (IT); UGO MADAMA, ROMA (IT); SANDRO PICCININI, ROMA (IT); STEFANO PROIETTI, ROMA (IT); MILKO VACCARO, ROMA (IT)

(73) Assignee: INTERNATIONAL BUSINESS MACHINES CORPORATION, ARMONK, NY (US)

(21) Appl. No.: 13/603,637

(22) Filed: Sep. 5, 2012

(51) Int. Cl. G06Q 10/10

(52) U.S. Cl. 705/7.16; 705/7.19

(57) ABSTRACT

Managing shared hardware assets within an organization includes determining a shared hardware asset utilized by at least one invitee to a meeting and calculating a workload for the shared hardware asset for each of a plurality of proposed meeting times for the meeting. The proposed meeting times are ranked according to a comparison of the workload for each proposed meeting with a shared hardware asset objective.

### BACKGROUND

Many organizations maintain various hardware assets that are shared among the members of the organization. Examples of shared hardware assets include computer systems such as servers and the like. Typically, users are able to reserve time on shared hardware assets through some sort of manual or electronic reservation system.

For example, during the course of software development, a developer often needs to utilize one or more shared hardware assets for testing purposes. The developer typically reserves a block of time on a shared hardware asset to conduct the necessary testing. The reservation may last several months. The shared hardware asset that is reserved by the developer appears, through the reservation system, to be unavailable for the entirety of the reservation, e.g., unavailable for months at a time. In many cases, however, there is little or no correlation between the reservation made for the shared hardware asset and the actual usage of the shared hardware asset resulting in inefficient asset utilization.

### BRIEF SUMMARY

One or more embodiments disclosed within this specification relate to managing the use of shared hardware assets within an organization.

One embodiment includes a method. The method includes determining a shared hardware asset utilized by at least one invitee to a meeting and calculating, using a processor, a workload for the shared hardware asset for each of a plurality of proposed meeting times for the meeting. The proposed meeting times are ranked according to a comparison of the workload for each proposed meeting with a shared hardware asset objective.

Another embodiment includes a system. The system includes a processor configured to initiate executable operations. The executable operations include determining a shared hardware asset utilized by at least one invitee to a meeting, calculating a workload for the shared hardware asset for each of a plurality of proposed meeting times for the meeting, and ranking the proposed meeting times according to a comparison of the workload for each proposed meeting with a shared hardware asset objective.

Another embodiment includes a computer program product for managing shared hardware assets. The computer program product includes a computer readable storage medium having stored thereon program code that, when executed, configures a processor to perform executable operations. The executable operations include determining a shared hardware asset utilized by at least one invitee to a meeting, calculating a workload for the shared hardware asset for each of a plurality of proposed meeting times for the meeting, and ranking the proposed meeting times according to a comparison of the workload for each proposed meeting with a shared hardware asset objective.

### BRIEF DESCRIPTION OF THE SEVERAL VIEWS OF THE DRAWINGS

FIG. 1 is a block diagram illustrating a system in accordance with an embodiment disclosed within this specification.

FIG. 2 is a block diagram illustrating an exemplary user interface for specifying a shared hardware asset profile in accordance with another embodiment disclosed within this specification.

FIG. 3 is a block diagram illustrating an example of a data processing system.

FIG. 4 is a block diagram illustrating a method of managing shared hardware assets in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous elements or features.

One or more embodiments disclosed within this specification relate to managing the use of shared hardware assets within an organization. Usage of shared hardware assets within an organization can be managed more efficiently through integration with a calendaring system available to users of the organization and by leveraging reservation data maintained for the shared hardware assets. In addition, various objectives can be defined by the organization as an entity that can be observed or enforced to control usage of shared hardware assets in accordance with the established objectives when scheduling meetings.

A “shared hardware asset” or a “shared hardware” refers to a physical resource that is used by more than one user within an organization. In some cases, usage by more than one user occurs concurrently. In other cases, the shared hardware asset is used by different users one at a time. An example of a shared hardware asset is a computer system such as a server (e.g., a Web server, a database server, etc.) or other computing infrastructure available for use by more than one user.

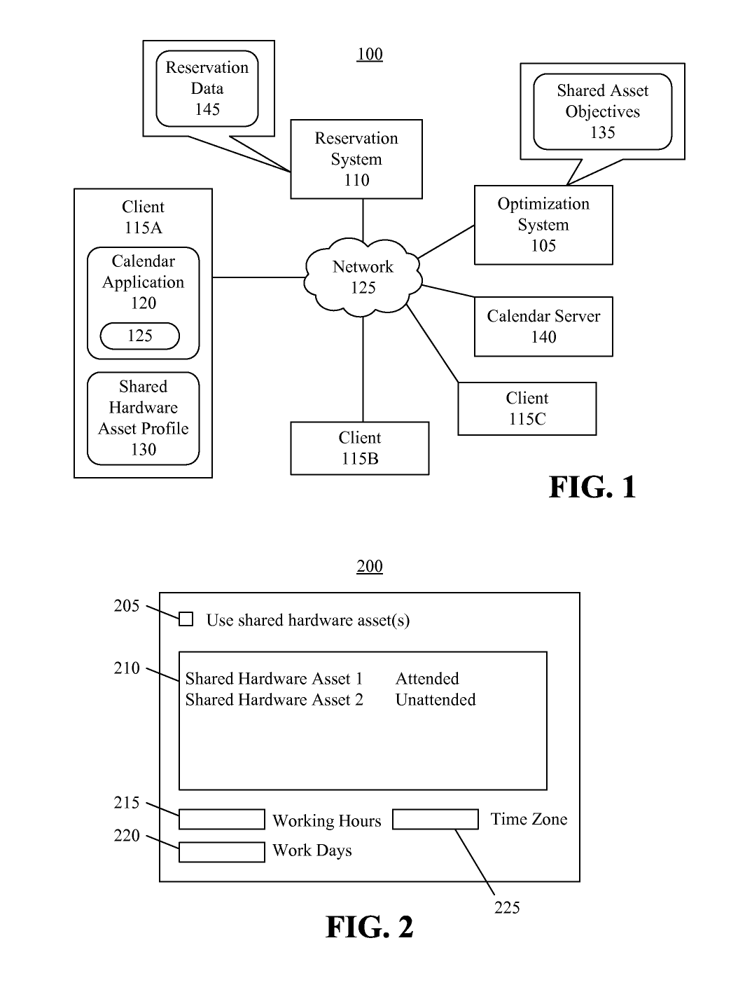

FIG. 1 is a block diagram illustrating a system 100 in accordance with an embodiment disclosed within this specification. As shown, system 100 includes an optimization system 105, a reservation system 110, a calendar server 140, and a plurality of clients 115A-115C each coupled through a network 125. In one aspect, optimization system 105, reservation system 110, calendar server 140, and clients 115A-115C each is implemented as a data processing system or a collection of data processing systems that operate cooperatively as described in further detail within this specification. The various elements illustrated in FIG. 1 communicate with one another through network 125. Network 125 can be implemented as, or include, any of a variety of different networks such as a WAN, a LAN, a wireless network, a mobile network, a Virtual Private Network (VPN), the Internet, or the like.

From time-to-time within this specification, reference to a client, such as any of clients 115A-115C, may also refer to, or reference, the particular user of that client. A “user” refers to a human being that operates or uses a particular data processing system such as one of clients 115A-115C. Similarly, reference to a user may also refer to, or reference, the client used by that user. As an example, a user scheduling a meeting refers to the user providing input to the client or other data processing system to schedule a meeting via, or using, the client and/or system.

As illustrated, client 115A executes and/or includes a calendar application 120. Calendar application 120 stores calendar information specifying an electronic schedule, or “calendar,” for the user of client 115A. The calendar includes a list of events associated with the user of client 115A. Each event, e.g., a meeting, is one in which the user has an interest, is a participant, is an invitee, etc. An event is defined by a date upon which the event occurs, a start time, and an end time. The start and end times define a duration for the meeting. The event further can specify additional information or attributes such as a location, a type, etc. Thus, calendar application 120 stores and maintains a list of the various events scheduled by the user of client 115A, meetings of interest in which the user of client 115A may not be a participant, and/or meetings in which the user of client 115A is a participant or invitee.

Calendar application 120 further executes and/or includes a client shared hardware asset component (client component) 125. In one aspect, client component 125 is implemented as a plug-in that cooperatively executes with, or within, calendar application 120. In another aspect, client component 125 is implemented as an extension to calendar application 120. In any case, client component 125 is able to interact with calendar application 120, access functions of calendar application 120, and further take action on behalf of calendar application 120 as described within this specification.

Client 115A further includes and/or stores a shared hardware asset profile 130. Shared hardware asset profile 130 is user specific data that specifies various attributes of the user in relation to shared hardware assets available for use within an organization and the usage thereof. In one aspect, shared hardware asset profile 130 is maintained and defined through client component 125 within, or as part of, calendar application 120.

For example, shared hardware asset profile 130 can include a checkbox or other indicator that, when selected by a user, indicates that the user is a user of one or more shared hardware assets of the organization. Shared hardware asset profile 130 further specifies a list of the particular shared hardware assets that are utilized by the user, e.g., the shared hardware assets for which the user has a reservation and/or is permitted to use (e.g., for which the user is permitted to make a reservation).

For each listed shared hardware asset within the shared hardware asset profile, a type of usage can be specified. An example of a type of usage is “attended” or “unattended.” An attended usage of a shared hardware asset by a user means that the user is located at, and using, the shared hardware resource. For example, referring to a computer system such as a server, an attended usage would mean that the user is located at a terminal or other interface and/or input/output (I/O) device that is communicatively coupled to the shared hardware asset reserved by the user. An unattended use of a shared hardware asset does not require the presence of the user at the shared hardware asset, an I/O device, or an interface of the shared hardware asset. For example, during an unattended usage, the user can be located at home or working at his or her desk away from the shared hardware asset and not monitoring the shared hardware asset. An unattended usage of a server, for example, includes the server executing a background process. As such, an unattended usage may permit load sharing while a process of one user executes in the background with one or more other processes.

Other information specified by shared hardware asset profile 130 includes working hours for the user. The working hours, for example, can be associated with, or specify, a time zone in order to correlate working hours and likely times of attendance of a reserved and shared hardware asset with other users across different time zones. For example, a shared hardware resource that is reserved for an entire day in an attended mode is not likely utilized outside of the regular business hours of the user that reserved the shared hardware asset. Still, in another aspect, working hours can be specified generally within shared hardware asset profile 130 for a user that would be applicable to each of the listed shared hardware assets and/or on a per shared hardware asset basis for shared hardware assets specified therein.

In another aspect, shared hardware asset profile 130 specifies a location for the user. In some cases, e.g., where client 115A is a mobile communication device, location changes and can be determined using Global Positioning System (GPS) data obtained using a GPS receiver within client 115A, or by determining the particular wireless network nodes, e.g., access points and/or mobile towers or cells, to which client 115A is communicating. In other cases, a user can manually specify a location that is stored within shared hardware asset profile. In still other cases, location can be determined by the particular machine or client into which the user has logged in. In any case, the location of client 115A, and thus the user of client 115A, can be updated within shared hardware asset profile 130 using any of a variety of different mechanisms.

As noted, shared hardware asset profile 130 is created or specified by a user through client component 125 of calendar application 120. Using client component 125, a user can specify or provide as much or as little of the aforementioned information as may be desired.

Clients 115B and 115C are configured and/or implemented in substantially the same way as client 115A. It should be appreciated, however, that the particular type of data processing system used to implement client 115B and/or client 115C need not be the same as that used to implement client 115A. Further clients 115B and 115C are used by, or associated with, different users.

Reservation system 110 is configured to store and/or maintain reservation data 145 for shared hardware assets of an organization. Each reservation of reservation data 145 specifies one or more shared hardware assets that are reserved, the date(s) the shared hardware assets are reserved, and optionally the times that the shared hardware assets are reserved. Thus, for each shared hardware asset that is to be managed, reservation system 110 can include a list of reservations (into the future) for that shared hardware asset. In one aspect, reservation data 145 further includes past reservation data (prior or expired reservations for shared hardware assets). It should be appreciated that a workload for a shared hardware asset can be calculated at any given time in the past and/or into the future from the reservation data for that shared hardware asset.

In general, a “workload” is an amount of work that is to be performed by a shared hardware asset at a particular time or during a particular time period. In terms of computing systems, a workload refers to a usage level that can be expressed as a percentage of the available computational power (e.g., of the processor, I/Os, etc.) of a computing system such as a shared hardware asset that is being utilized. More specifically, a workload specifies an estimate of the amount of work a shared hardware asset will perform at a time or during a time period in the future. The workload of a shared hardware asset can be determined from an analysis of existing reservations, historical reservation data, cancellations, trend analysis, or the like.

In one aspect, reservation system 110 includes an optimization component (not shown). The optimization component is configured to determine a workload for the various shared hardware assets managed by reservation system 110. In one aspect, the workload can be calculated for a particular shared hardware asset, for two or more particular shared hardware assets, or for all shared hardware assets. A workload for a plurality of shared hardware assets can be expressed as a function of the workload for each individual or respective shared hardware asset of the plurality being considered, e.g., a sum, an average, or the like.

In one aspect, optimization system 105 is configured to store, or aggregate, data and make the data available to one or more requesting clients. For example, optimization system 105 can be configured to store shared hardware asset profiles from one or more or all users and provide the shared hardware asset profiles for selected users to a requesting client. In another example, optimization system 105 can obtain reservation data 145, or some subset thereof, from reservation system 110 and provide reservation data 145, or some subset thereof, including a workload, to a requesting client for one or more shared hardware assets.

In another aspect, optimization system 105 stores one or more shared hardware asset objectives 135. In general, each shared hardware asset objective 135 defines how and when shared hardware assets are to be used. Each shared hardware asset objective 135 specifies a target or requirement to be met across an organization with respect to one or more shared hardware assets. In this regard, a shared hardware asset objective can be specific to a shared hardware asset or applied to two or more or all of the shared hardware assets.

Examples of shared hardware asset objectives 135 include a directive indicating that the workload of a shared hardware asset is to be maximized, balanced, or reduced. In another example, shared hardware asset objectives 135 can specify that one or more shared hardware assets are to be operated in a manner (e.g., a particular off-peak times) that result in a reduction in of energy costs. Shared hardware asset objectives 135 further can specify a target workload, a maximum workload (e.g., as a function or result of a service level agreement for a shared hardware asset), or the like, for one or more shared hardware assets. One or more shared asset objectives 135 can be defined and in effect at any given time.

Thus, in scheduling a meeting, a client such as client 115A and/or optimization system 105 can evaluate reservation data 145, a workload of one or more shared hardware assets, shared hardware asset profiles for invitees to the meeting, and shared hardware asset objectives 135 in either determining proposed meeting times or in ranking proposed meeting times.

Calendar server 140 is configured to facilitate the sharing of calendar information among users. In one aspect, calendar server 140 can store calendars of users to facilitate synchronization of calendar information across a plurality of different clients for a user. Accordingly, each client, when scheduling a meeting, can access calendar server 140 to obtain the calendar for invitees to a meeting that is being scheduled. A “calendar system,” as used herein, refers to a server (data processing system) executing calendar management software for one or more users, a client (data processing system) executing a calendar application, or a combination of a server executing calendar management software and one or more clients using calendar management software configured to interact with the server.

Reservation system 110 and calendar server 140 are illustrated as separate and independent systems within FIG. 1. In another aspect, however, the functions of reservation system 110 and calendar server 140 can be merged into a single system. For example, reservation data 145 for shared hardware assets can be stored within, or determined from, reservations or meetings specifying shared hardware assets scheduled within a calendar system.

In operation, a user of client 115A, e.g., an organizer of a meeting, can create an invitation for a meeting to be scheduled using calendar application 120. The invitation specifies attributes for the meeting including the invitees to the meeting and a type of the meeting. The organizer of a meeting is considered an invitee for purposes of discussion. Client component 125 is configured to interact with calendar application 120. Calendar application 120, for example, can generate one or more proposed meeting times for which the invitees are available (or at least those invitees determined to be, or designated as, mandatory invitees). Client component 125, in interacting with calendar application 120, can rank the proposed meeting times.

In one aspect, the proposed meeting times are ranked according to the shared hardware asset profiles of one or more invitees to the meeting, reservation data 145, a workload for one or more shared hardware assets during each proposed meeting time, shared hardware objective(s) 135, or any combination of the foregoing. The proposed meeting times, with any determined ranking, are presented to the organizer for selection via calendar application 120. Once a proposed meeting time is selected, the proposed meeting time that is selected is added to the invitation, which then can be distributed to the invitees for acceptance and scheduling of the meeting within the calendaring system.

FIG. 2 is a block diagram illustrating an exemplary user interface 200 for specifying a shared hardware profile in accordance with another embodiment disclosed within this specification. User interface 200 can be generated by the client and, in particular, client component 125 in cooperation with calendar application 120. As discussed, each shared hardware asset profile is user-specific.

As pictured, user interface 200 includes a check box 205 allowing the user to indicate that he or she is a user of shared hardware assets. List box 210 is configured to receive user inputs specifying each shared hardware asset for which the user has a reservation and/or for which the user is permitted to use (make a reservation). The user can indicate whether the usage type for each listed shared hardware asset is attended or unattended.

Data entry field 215 is configured to receive user input specifying the working hours for the user, e.g., a starting time and an ending time of the day for the user. Data entry field 220 is configured to receive user input specifying the work days for the user, e.g., Monday, Tuesday, Wednesday, Saturday, etc. Data entry box 225 is configured to receive a user input specifying a time zone in which the user is located.

User interface 200 is presented for purposes of illustration only and is not intended to limit the various embodiments disclosed within this specification. For instance, the particular types of user activatable controls described and shown can be changed and/or replaced by other types of data entry controls. For example, drop down selection lists can be used in lieu of text entry fields, etc.

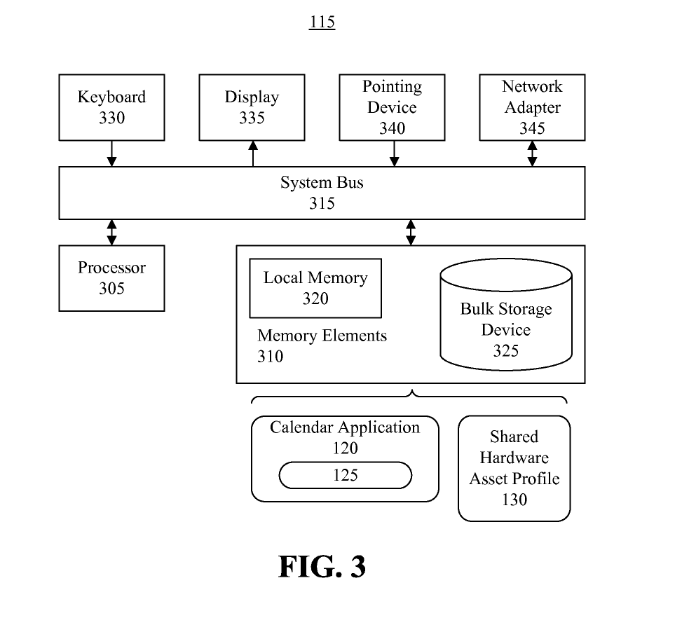

FIG. 3 is a block diagram illustrating an example of a data processing system that can be used to implement clients 115 of FIG. 1. Client 115 can include at least one processor 305 coupled to memory elements 310 through a system bus 315 or other suitable circuitry. As such, client 115 can store program code within memory elements 310. Processor 305 can execute the program code accessed from memory elements 310 via system bus 315. In one aspect, for example, client 115 can be implemented as a computer that is suitable for storing and/or executing program code. It should be appreciated, however, that client 115 can be implemented in the form of any system including a processor and memory that is capable of performing the functions and/or operations described within this specification. For example, client 115 can be implemented as a portable computer, a tablet computer, a mobile communication device, or the like.

Memory elements 310 can include one or more physical memory devices such as, for example, local memory 320 and one or more bulk storage devices 325. Local memory 320 refers to RAM or other non-persistent memory device(s) generally used during actual execution of the program code. Bulk storage device(s) 325 can be implemented as a hard disk drive (HDD), solid state drive (SSD), or other persistent data storage device. Client 115 also can include one or more cache memories (not shown) that provide temporary storage of at least some program code in order to reduce the number of times program code must be retrieved from bulk storage device 325 during execution.

I/O devices such as a keyboard 330, a display 335, and a pointing device 340 optionally can be coupled to client 115. The I/O devices can be coupled to client 115 either directly or through intervening I/O controllers. One or more network adapters 345 also can be coupled to client 115 to enable client 115 to become coupled to other systems, computer systems, remote printers, and/or remote storage devices through intervening private or public networks. Modems, cable modems, and Ethernet cards are examples of different types of network adapters 345 that can be used with client 115.

As pictured in FIG. 3, memory elements 310 can store calendar application 120, client component 125, and shared hardware asset profile 130. Calendar application 120 and client component 125, being implemented in the form of executable program code, can be executed by client 115 and, as such, can be considered part of client 115. Client 115, executing the aforementioned program code, is configured to perform the various functions described within this specification.

While FIG. 3 illustrates an implementation of client 115, the architecture pictured in FIG. 3 also can be used to implement one or more of optimization system 105, reservation system 110, and/or calendar server 140 of FIG. 1. Appreciably, when used to implement other processing nodes, the data processing system of FIG. 3 executes different operational software suitable for performing the functions and/or operations described within this specification.

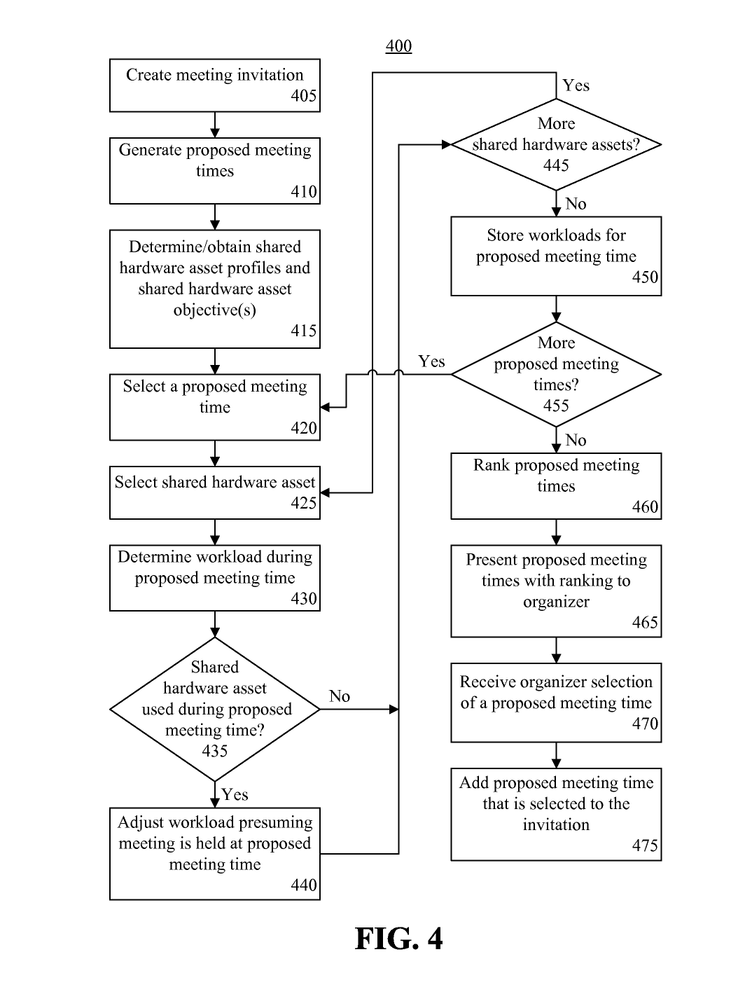

FIG. 4 is a block diagram illustrating a method 400 of managing shared hardware assets in accordance with another embodiment disclosed within this specification. Method 400 can be implemented by a system as illustrated with reference to FIGS. 1-3 of this specification.

In block 405, a meeting invitation is created. For example, an organizer, working through a client executing a calendar application and a client component as described, creates or generates an invitation for a meeting. The invitation specifies a list of invitees to the meeting. In one aspect, the invitation further specifies an expected duration or length of time for the meeting, but not specific starting and ending times. Invitees can be designated as mandatory, optional, or the like. As discussed, the organizer is considered an invitee of the meeting. In another aspect, the organizer can specify attributes for the meeting such as a type. Examples of meeting types include, but are not limited to, “teleconference,” “in-person meeting,” “client site meeting,” “Web conference,” “video-conference,” or the like. In general, the meeting type specifies the form of communication that is to take place. In another example, the invitation can specify an attribute such as a location for the meeting. The location indicates where the meeting is to take place. At this point in time, the meeting invitation is only partially complete since a meeting data and specific time has not yet been determined for the meeting.

In one aspect, one or more types of meeting can be flagged as having a shared hardware asset priority above other types of meetings. For example, an invitation can be flagged using the data entry control to indicate that the meeting is a “demonstration” for a product. The product to be demonstrated may be a shared hardware asset or a product that relies upon a shared hardware asset.

In block 410, the calendar system can generate one or more proposed meeting times for the meeting. The proposed meeting times can have various starting and ending times, occur over various dates, etc. In one aspect, the calendar system determines the proposed meeting times according to availability information from the calendar system for each invitee or for at least each mandatory invitee. The proposed meeting times are times that each of the invitees, or at least the mandatory invitees, are available per their respective calendars.

In block 415, the client determines and/or obtains various items of information including the shared hardware asset profile for each invitee and/or each mandatory invitee and any shared hardware asset objectives. In one aspect, the client component obtains the shared hardware asset profiles by requesting the information for each invitee, as specified within the invitation, from the optimization system. In another aspect, the client component broadcasts a request to each invitee (a client of each invitee) requesting the shared hardware asset profile for the invitee using a peer-to-peer communication model. The client further can request the shared asset objectives from the optimization system, which in turn sends the requested data to the client for use by the client component. It should be appreciated that by obtaining the shared hardware asset profiles, the client component has a list of shared hardware assets used by each invitee or each mandatory invitee.

In block 420, the client begins a process of evaluating and ranking the proposed meeting times according to the effect each proposed meeting time has upon meeting the shared hardware asset objective(s) for the organization. Accordingly, in block 420, the client selects a proposed meeting time from those generated in block 410. In block 425, the client selects a shared hardware asset specified in the shared hardware asset profiles obtained in block 415.

In block 430, the client obtains a workload for the shared hardware asset selected in block 425. The workload can be obtained from the optimization server and/or the reservation system as previously described via a request from the client. In block 435, the client determines whether the shared hardware asset is scheduled for use during the proposed meeting time selected in block 420. The client, for example, can obtain reservation data from the optimization system and/or the reservation system for the shared hardware asset. If so, method 400 continues to block 440. If not, method 400 proceeds to block 445.

In block 440, the client adjusts the workload, if applicable, for the shared hardware asset presuming that the meeting is held at the proposed meeting time selected in block 420. In one aspect, the workload is adjusted according, at least in part, to the meeting type as determined from the invitation and the usage type for the shared hardware asset as determined from the shared hardware asset profile for the particular invitee that reserved the shared hardware asset.

For example, if the shared hardware asset is to be attended during the proposed meeting time and the meeting is an “in-person” meeting, the shared hardware asset will be available during the proposed meeting time, thereby decreasing the workload on the shared hardware asset for the duration of the proposed meeting time. If the shared hardware asset is to be unattended during the proposed meeting time, the workload remains the same.

In another example, for a meeting that is a teleconference, a Web conference, or uses another type of communication channel not requiring in-person attendance, the workload for the shared hardware asset remains constant whether usage is attended or unattended as the user can participate in the meeting at the proposed meeting time and continue to utilize the shared hardware asset.

In other examples, the location specified by the invitation can be used in combination with the usage type of the shared hardware asset and/or the meeting type. For example, a location that is off-site from the organization so that the invitee has no access to a secure network connection means that the user is not able to use a shared hardware asset reserved during the proposed meeting time if scheduled for attended usage. Accordingly, the workload of the shared hardware asset is reduced during the proposed meeting time.

In still another example, for those situations or cases in which an invitee is determined not to be able to use a shared hardware asset during the proposed meeting time, the shared hardware asset can be “unreserved” for that time, thereby allowing other users to access and/or utilize the shared hardware asset for the proposed meeting time. For instance, when a meeting is subsequently scheduled, e.g., is no longer a proposed meeting time, but rather an actual meeting time accepted by the invitee, and the invitee is unable to use the shared hardware asset during that time, the shared hardware asset can be unreserved for the time of the meeting. The client and/or the optimization system, for example, can modify the reservation for the shared hardware asset within the reservation system to indicate that the share hardware asset is available (not reserved) for the time of the meeting.

Continuing with block 445, the client determines whether any more shared hardware assets remain to be processed. If so, method 400 loops back to block 425 to continue processing as described. If not, method 400 continues to block 450. In block 450, the client stores the workloads for the proposed meeting time. More particularly, the client stores the workloads for the shared hardware assets listed within each shared hardware asset profile of the invitees (or at least the mandatory invitees) for the proposed meeting time.

In block 455, the client determines whether any further proposed meeting times remain to be processed. If so, method 400 loops back to block 420 to continue processing. If not, method 400 continues to block 460.

In block 460, the client ranks the proposed meeting times. In one aspect, the client ranks the proposed meeting times according to the workloads for the shared hardware assets from the shared hardware asset profiles of invitees and the shared hardware asset objectives. For example, if energy conservation is to be optimized per the shared hardware asset objective, the client can determine the energy consumption for each proposed meeting time given effective power rates at in effect at each proposed meeting time and the workload for each shared hardware asset. The proposed meeting times are ranked with the proposed meeting time that would result in the greatest energy savings ranked first and the proposed meeting time that would result in the lowest energy savings ranked last.

In another example, the shared hardware asset objectives can indicate that workloads are to be minimized for one or more shared hardware assets. In that case, the client can rank the proposed meeting times so that the proposed meeting time that has the lowest workload is ranked highest, while the proposed meeting time that has the highest workload is ranked lowest.

In another example, the shared hardware asset profiles can specify that usage of one or more shared hardware assets are to be maximized. In that case, the client can rank proposed meeting times according to which proposed meeting time results in a workload that is closest to a target or maximum workload for one or more shared hardware assets without going over the target or maximum workload. The proposed meeting time with the closest workload without exceeding the target workload is ranked highest.

In block 465, the proposed meeting times are presented to the organizer with the determined ranking. For example, the proposed meeting times can be visually indicated to the organizer via the calendar application of the client. Each proposed meeting time can have a visual indicator of the rank or desirability of the proposed meeting time, e.g., a number or color coding. The organizer can select a proposed meeting time that most closely tracks or conforms to the shared hardware asset objective for the organization.

In block 470, the client receives a user input from the organizer selecting a proposed meeting time. In block 475, the proposed meeting time selected by the organizer is included within, or added to, the invitation. Accordingly, the organizer can send the invitation to the invitees and continue as normal in terms of scheduling the meeting.

Method 400, as presented in FIG. 4, is described in terms of being performed by the client. In another aspect, the client of the organizer is configured to send the invitation, or attributes extracted from the invitation, and proposed meeting times to the optimization system, which can rank the proposed meeting times, and send the ranked proposed meeting times back to the client for presentation to the user.

In another aspect, responsive to a meeting designated as a demonstration, or otherwise flagged as described, being scheduled, the optimization system can lower the maximum workload allowed for the shared hardware asset involved in the demonstration. The optimization system can, for example, modify the applicable shared hardware asset objective to specify a lower maximum workload for the particular shared hardware asset that is involved in, or used during, the priority meeting. The maximum workload can be lowered by a predetermined amount or percentage or lowered to a predetermined workload. This ensures that adequate resources are available for the demonstration by ranking proposed meeting times for others higher that result in lower usage of the relevant shared hardware asset during the demonstration time.

In another aspect, when a demonstration is scheduled by a client, the client can submit a request to the optimization system to lower the workload for the particular shared hardware asset that is involved in the demonstration. In response, the optimization system can select the applicable shared hardware asset objective and modify it as appropriate.

A meeting is scheduled when the invitation is accepted by one or more invitees or the required invitees. Lowering the maximum workload for a shared hardware asset effectively ranks meetings that maintain the workload constant or result in lowering the workload of the relevant shared hardware asset.

In still another aspect, the optimization system can trigger the rescheduling of meetings based upon selected criteria. For example, the optimization system can initiate the rescheduling of meetings in the event that the shared hardware asset objective is modified. For example, responsive to the lowering of a maximum workload, the optimization system can identify meetings that, were the meeting to be rescheduled, would result in lowering of the workload in conformance with the modified shared hardware asset objective. In that case, the optimization system can send a notification to the organizer and/or the invitees requesting that the meeting be rescheduled. The organizer can implement the process described with reference to FIG. 4, or another process, that utilizes the newly modified or updated shared hardware asset objective(s).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

What is claimed is:

1. A method, comprising:
determining a shared hardware asset utilized by at least one invitee to a meeting;
calculating, using a processor, a workload for the shared hardware asset for each of a plurality of proposed meeting times for the meeting; and
ranking the proposed meeting times according to a comparison of the workload for each proposed meeting with a shared hardware asset objective.

2. The method of claim 1, further comprising:
displaying the ranked proposed meeting times via a calendar application within a client.

3. The method of claim 1, wherein calculating a workload for the shared hardware asset for each of the plurality of proposed meeting times for the meeting is dependent upon whether the shared hardware asset is reserved by an invitee during the proposed meeting time and is attended.

4. The method of claim 1, wherein calculating a workload for the shared hardware asset for each of the plurality of proposed meeting times for the meeting is dependent upon whether the meeting permits remote attendance.

5. The method of claim 1, wherein the shared hardware asset is identified from a shared hardware asset profile maintained within a calendar system for at least one invitee.

6. The method of claim 1, further comprising:
responsive to a detected change in the shared hardware objective, sending a request to at least one invitee to reschedule the meeting.

7. The method of claim 1, further comprising:
responsive to identifying a scheduled meeting of a flagged meeting type indicating shared hardware asset priority, reducing a maximum workload allowed for a shared hardware asset involved during the scheduled meeting.

8. A system comprising:
a processor configured to initiate executable operations comprising:
determining a shared hardware asset utilized by at least one invitee to a meeting;
calculating a workload for the shared hardware asset for each of a plurality of proposed meeting times for the meeting; and
ranking the proposed meeting times according to a comparison of the workload for each proposed meeting with a shared hardware asset objective.

9. The system of claim 8, wherein the processor is further configured to initiate an executable operation comprising:
displaying the ranked proposed meeting times via a calendar application within a client.

10. The system of claim 8, wherein calculating a workload for the shared hardware asset for each of the plurality of proposed meeting times for the meeting is dependent upon whether the shared hardware asset is reserved by an invitee during the proposed meeting time and is attended.

11. The system of claim 8, wherein calculating a workload for the shared hardware asset for each of the plurality of proposed meeting times for the meeting is dependent upon whether the meeting permits remote attendance.

12. The system of claim 8, wherein the shared hardware asset is identified from a shared hardware asset profile maintained within a calendar system for at least one invitee.

13. The system of claim 8, wherein the processor is further configured to initiate an executable operation comprising:
responsive to a detected change in the shared hardware objective, sending a request to at least one invitee to reschedule the meeting.

14. The system of claim 8, wherein the processor is further configured to initiate an executable operation comprising:
responsive to identifying a scheduled meeting of a flagged meeting type indicating shared hardware asset priority, reducing a maximum workload allowed for a shared hardware asset involved during the scheduled meeting.

15. A computer program product for managing shared hardware assets, the computer program product comprising:
a computer readable storage medium having stored thereon program code that, when executed, configures a processor to perform executable operations comprising:
determining a shared hardware asset utilized by at least one invitee to a meeting;
calculating a workload for the shared hardware asset for each of a plurality of proposed meeting times for the meeting; and
ranking the proposed meeting times according to a comparison of the workload for each proposed meeting with a shared hardware asset objective.

16. The computer program product of claim 15, wherein the computer readable storage medium further stores program code that, when executed, configures a processor to perform an executable operation comprising:
displaying the ranked proposed meeting times via a calendar application within a client.

17. The computer program product of claim 15, wherein calculating a workload for the shared hardware asset for each of the plurality of proposed meeting times for the meeting is dependent upon whether the shared hardware asset is reserved by an invitee during the proposed meeting time and is attended.

18. The computer program product of claim 15, wherein calculating a workload for the shared hardware asset for each of the plurality of proposed meeting times for the meeting is dependent upon whether the meeting permits remote attendance.

19. The computer program product of claim 15, wherein the shared hardware asset is identified from a shared hardware asset profile maintained within a calendar system for at least one invitee.

20. The computer program product of claim 15, wherein the computer readable storage medium further stores program code that, when executed, configures a processor to perform an executable operation comprising:
responsive to a detected change in the shared hardware objective, sending a request to at least one invitee to reschedule the meeting.
